(19) United States
(12) Patent Application Publication
(10) Pub. No.: US 2013/0147126 A1
(43) Pub. Date: Jun. 13, 2013

(54) SEAL MEMBER

(71) Applicant: ROKI CO., LTD., Hamamatsu-shi (JP)

(72) Inventors: Taisuke SATO, Hamamatsu-shi (JP); Takenori SUZUKI, Hamamatsu-shi (JP)

(73) Assignee: ROKI CO., LTD., Hamamatsu-shi (JP)

(21) Appl. No.: 13/692,590

(22) Filed: Dec. 3, 2012

(30) Foreign Application Priority Data
Dec. 12, 2011 (JP) 2011-271254

(51) Int. Cl. F02F 11/00

(52) U.S. Cl. CPC F02F 11/00
USPC 277/591

(57) ABSTRACT

A seal member has a ring shape which is assembled in a portion between a tubular member to be inserted into and fixed to a mount hole formed to a head cover of an internal combustion engine and a peripheral wall portion of the mount hole. The seal member is provided with an axial-direction seal portion formed to axial one end portion of the seal member, and a diameter-direction seal portion formed to another one end of the seal member. A fixing member configured to fix movement in a diameter direction of the seal member between the axial-direction seal portion and the diameter-direction thereof is formed along a peripheral wall portion of the mount hole.

### BACKGROUND OF THE INVENTION

1. Field of the Invention

The present invention relates to a seal member, and particularly, to a seal member interposed between an ignition plug mount hole formed to a head cover of an internal combustion engine and a mount member into which an ignition plug is inserted.

2. Related Art

It is conventionally known that a head cover made of synthetic resin is attached to an upper portion of an internal combustion engine for the purpose of realizing lightweight and improving design performance. In such structure, an ignition plug is mounted to the upper portion of the internal combustion engine, the ignition plug is inserted into a mount member such as tubular (cylindrical) plug tube, and the plug tube is inserted into an ignition plug mount hole formed to the head cover.

In the above conventional structure, a seal member is also interposed between the plug tube and the ignition plug mount hole for the purpose of liquid-tightly sealing a gap therebetween. For this purpose, many method and structure for mounting the seal member have been conventionally proposed, for example, as disclosed in Patent Document 1 (Japanese Patent Laid-open Publication No. 2004-52705) and Patent Document 2 (Japanese Patent Laid-open Publication No. 2007-321605).

A seal member disclosed in the Patent Document 1 is formed with an elastic material so as to elastically closely contact around an entire outer periphery of a plug tube, and the thus formed seal member is integrally supported by a support member made of rigid material to be detachably fastened to a head cover in a manner such that at a time of fastening the support member to the head cover, a ring-shaped (annular) retaining seal portion elastically closely contacting an inner surface of the head cover around the periphery of the ignition plug mount hole.

As mentioned above, the seal member disclosed in the Patent Document 1 ensures the fixing of the seal member to the head cover by fastening the support member to the head cover, and even if the head cover is deformed, the sealing performance of the seal member can be surely maintained.

In the meantime, the Patent Document 2 discloses a seal member to be assembled by inserting the seal member into a peripheral wall portion of a mount hole formed to a head cover made of synthetic resin, and a tubular portion and a flanged portion are formed on the mount hole peripheral wall portion side and a large diameter portion, a small diameter portion and a projecting portion are formed on the seal member side so as to provide a irregular shape having protruded and recessed portions, which are to be mutually engaged with each other, are formed to the inner peripheral portion of a mount hole peripheral wall portion and the outer peripheral portion of the seal member closely contacting the inner peripheral portion of the mount hole wall, respectively.

As mentioned above, with the structure of the Patent Document D2, the seal member can be strongly assembled, without staggering in an axial direction or diametrical direction, to the mount hole peripheral wall portion in a fashion such that the inner peripheral portion and the outer peripheral portion, to which the protruded and recessed portions are formed, are closely contacted, by inserting the seal member into the mount hole peripheral wall portion to thereby preventing unintentional fall-down or position-shifting from being caused by vibration or like from the internal combustion engine. Furthermore, since any parts or member such as fastening fitting or bracket for attaching the seal member to the mount hole peripheral wall portion is not required, resulting in reduction of members or parts to be used and realizing lightweight and down-sizing as well as easy assembling working.

However, in the seal member attaching method disclosed in the Patent Document 1, since the supporting member of the seal member is fastened in a fixed manner, the number of the parts or members increases, which results in increase in weight of entire structure and increase in assembling or mounting working processes as well as difficulty of attaching and/or detaching the seal member, thus being inconvenient.

Moreover, in the seal member attaching method disclosed in the Patent Document 2, since the seal member and the head cover are assembled in protrusion-recess engaging manner, there is a possibility of causing a fear of shifting in assembled state due to thermal deformation, vibration, wearing and the like, which may result in damage on sealing performance, thus also being inconvenient.

### SUMMARY OF THE INVENTION

The present invention was conceived in consideration of the circumstances mentioned above and an object thereof is to provide a seal member capable of surely sealing a seal member and a head cover without increasing number of parts and number of assembling working processes and without causing shifting in location of the seal member due to thermal deformation, vibration, wearing and the like.

The above and other objects can be achieved according to the present invention by providing a seal member having a ring shape which is assembled in a portion between a tubular member to be inserted into and fixed to a mount hole formed to a head cover of an internal combustion engine and a peripheral wall portion of the mount hole, the seal member including: an axial-direction seal portion formed to axial one end portion of the seal member; a diameter-direction seal portion formed to another one end of the seal member; and a fixing member formed along a peripheral wall portion of the mount hole and configured to fix movement in a diameter direction of the seal member between the axial-direction seal portion and the diameter-direction seal portion.

In preferred embodiments of the above aspect of the present invention, it may be desired that the fixing member is provided with a flanged portion extending in the diameter direction and a fixing wall portion extending downward from the flanged portion in parallel with the peripheral wall portion of the mount hole.

The axial-direction seal portion may be formed so as to project from the axial end portion of the seal member in the axial direction thereof. The diameter-direction seal portion is formed so as to project from the diameter direction of the seal member.

It may be further desired that the seal member further includes a reinforcing member made of metal disposed along a circumferential direction of the seal member. The reinforcing member may have an end portion on the axial-direction seal portion side, the end portion being bent in the diameter direction.

The embodiment of the present invention described above does not includes all the essential characteristic and structural features and may include sub-combination thereof that constitutes the present invention.

According to the present invention of the preferred characters and structures mentioned above, the following advantages effects and/or functions are attainable.

In the main aspect of the present invention, the seal member includes an axial-direction seal portion formed to axial one end portion of the seal member, and a diameter-direction seal portion formed to another one end of the seal member, and in addition, a fixing member is formed along a peripheral wall portion of the mount hole, the fixing member being configured to fix movement in a diameter direction of the seal member between the axial-direction seal portion and the diameter-direction thereof. Accordingly, since the peripheral wall portion of the mount hole and the fixing portion are mutually engaged and fitted with each other, there is no caused any shifting in location of the seal member by thermal deformation, vibration, wearing or like, thus performing sure sealing between the seal member and the head cover of the internal combustion engine.

Furthermore, according to further desired embodiments or example mentioned above, since the seal member is provided with a flanged portion extending in the diameter direction and a fixing wall portion extending downward from the flanged portion in parallel with the peripheral wall portion of the mount hole, the fixing wall portion and the peripheral wall portion can be engaged to thereby prevent the shifting of the seal member.

Furthermore, since axial-direction seal portion may be formed so as to project from the axial end portion of the seal member in the axial direction thereof, and the diameter-direction seal portion may be also formed so as to project from the diameter direction of the seal member, the sealing between the seal member and the plug cap and the sealing between the inner wall surface of the peripheral wall portion and the seal member can be surely realized.

Moreover, since the seal member may be further provided with the reinforcing member having an end portion on the axial-direction seal portion side, and the end portion is bent in the diameter direction, strength of the axial seal portion and in the diameter direction can be both ensured, so that the sealing of the axial-direction seal portion and the diameter-direction seal portion of the seal member can be surely performed.

The nature and further characteristic feature of the present invention will be made clearer from the following descriptions made with reference to the accompanying drawings.

### BRIEF DESCRIPTION OF THE DRAWINGS

In the accompanying drawings:

FIG. 1 is a sectional view showing a mounting state of a seal member according to a first embodiment of the present invention;

FIG. 2 is a sectional view illustrating a developed state of the seal member according to the first embodiment;

FIG. 3 is a perspective view showing the seal member according to the first embodiment;

FIG. 4 is an enlarged view showing an encircled portion A in FIG. 1; and

FIG. 5 is a sectional view showing a structure of a seal member according to a second embodiment of the present invention.

### DESCRIPTION OF THE PREFERRED EMBODIMENT

Hereunder, preferred embodiments of the present invention will be described with reference to the accompanying drawings. It is further to be noted that the embodiments described hereinafter do not limit the invention defined in respective appended claims, and all the combination of characteristic features explained for the embodiments in the specification is not always essential for the achievement of the present invention.

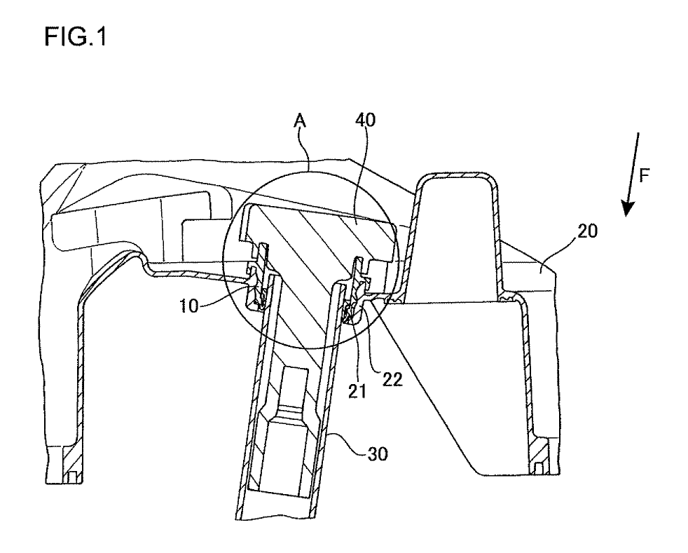

In FIG. 1, character “F” is an insertion direction along an axial direction of a seal member 10, a mount hole 21, tubular member 30 and a plug cap 40.

### First Embodiment

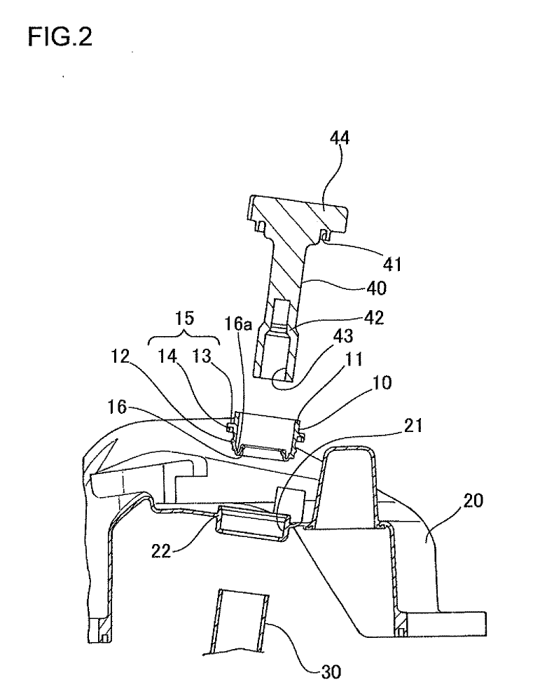

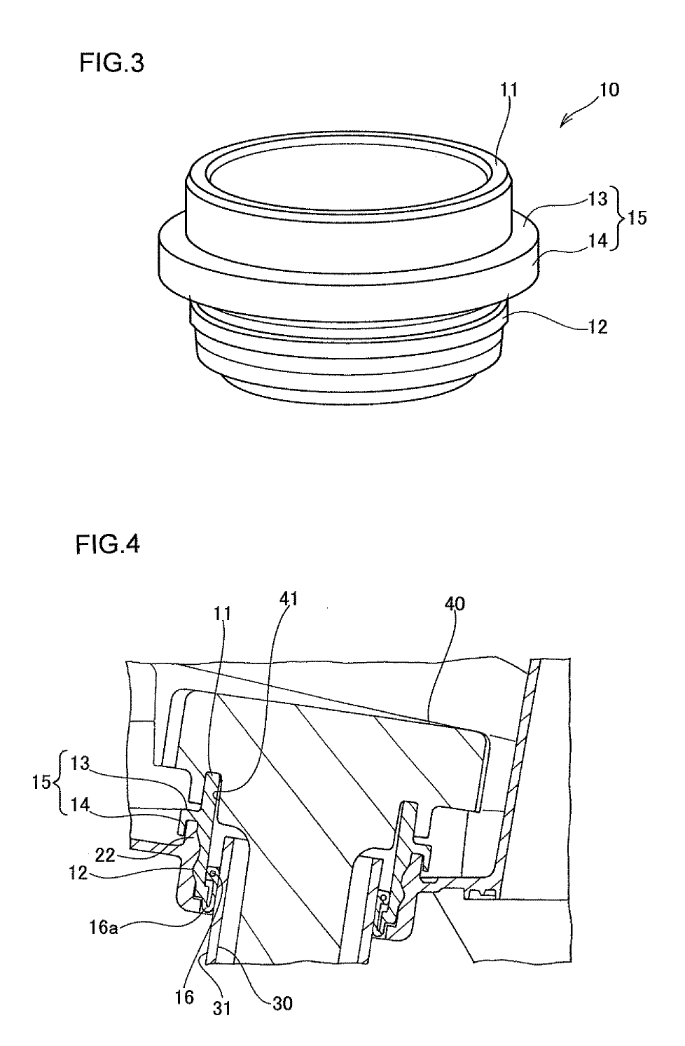

FIG. 1 is a sectional view showing a mounting state of a seal member according to a first embodiment of the present invention, FIG. 2 is a sectional view illustrating a developed state of the seal member of the first embodiment, FIG. 3 is a perspective view showing the seal member, and FIG. 4 is an enlarged view showing an encircled portion A in FIG. 1.

As shown in FIGS. 1 and 2, the seal member 10 according to the present embodiment is formed so as to provide a ring or annular shape. When the seal member 10 is inserted, along an insertion direction F, into the mount hole 21 formed in the head cover 20 of an internal combustion engine, and assembled between a peripheral wall portion 22 of the mount hole 21 and the tubular (cylindrical) member 30 fixed to the internal combustion engine.

As shown in FIG. 3, the seal member 10 has one and another ends in the axial direction thereof. The one end is formed with an axial-direction seal portion 11 in a manner projecting from the axial end of the seal member 10 in the axial direction thereof, and the other one end is formed with a diameter-direction seal member 12 projecting outward from the outer peripheral wall section of the seal member 10 in the diameter direction thereof. In addition, as shown in FIG. 2, a retaining portion (retainer) 12 is formed to the inner peripheral portion of the seal member so as to closely contact the outer peripheral portion of a tubular member 30 to be mentioned hereinafter, the tubular member 30 being integrally formed with a lower end portion of the seal member 10 through a connecting portion 16a.

Furthermore, a fixing portion 15 is formed between the axial-direction seal portion 11 and the diameter-direction seal portion 12 along the axial direction thereof. The fixing portion 15 is provided with a flanged portion 13 formed to the outer peripheral wall portion so as to project outward in the diameter direction thereof and with a fixing wall portion 14 formed so as to extend downward from the end of the flanged portion 13. The fixing wall portion 14 is formed so as to extend in parallel with a peripheral wall portion 22 to be mentioned hereinafter.

Still furthermore, the seal member 10 is made of an elastic material, and specifically, of acrylic rubber, silicone rubber, nitric rubber (NBR), ethylene propylene rubber (EPDM) or like. If the seal member 10 is made of an elastic material, since the axial-direction seal portion 11 and the diameter-direction seal portion 12 become deformable, the seal member 10 can be easily fitted into the mount hole 21 with a small press-fit force.

The head cover 20 is a member made of synthetic resin and is formed with the mount hole 21 into which the tubular member 30 mounted to the internal combustion engine can be inserted. The mount hole 21 is provided with a tubular peripheral wall portion 22 extending in the axial direction along an outer edge of the mount hole 21.

As shown in FIGS. 1 and 2, the plug cap 40 is a member to be inserted into the head cover 20 from the outside thereof along the axial direction, and when the plug cap 40 is connected to the ignition plug assembled in the tubular member 30, electric power is supplied to the ignition plug. The plug cap 40 is composed of a shank portion 42 and a flanged portion 44. The shank portion 42 is a portion to be inserted into the tubular member 30 and is provided with a plug hole 43 into which the ignition plug can be fitted. The flanged portion 44 is formed so as to extend, from one end of the shank portion, in a plane perpendicular to the axial direction of the shank portion 42. The flanged portion 44 is formed with a seal groove 41 along an outside surface of the shank portion 42.

In the following, the mounting method of the seal member 10 according to the present embodiment will be described with reference to FIG. 4.

Since the retaining portion 16 has a diameter smaller than the outer diameter of the tubular member 30, it is possible for the retaining portion 16 to contact the tubular member with a predetermined margin. According to such structure, the seal member 10 attains sealing performance between the seal member 10 and the tubular member 30 through abutment of the retaining portion 16 against the outer peripheral surface 31 of the tubular member 30.

Furthermore, since the diameter-direction seal portion 12 formed to the seal member 10 projects in the diameter direction, by fitting the seal member 10 to the mount hole 21, the seal member can be fitted under small press-fit force to the inner peripheral surface of the peripheral wall portion 22, thereby performing the sealing function between the seal member 10 and the mount hole 21 formed in the head cover 20.

In the meantime, the shank seal portion 11 formed to the seal member 10 fits into the seal groove 41 formed to the plug cap 40 at a time when the plug cap 40 is assembled. The plug cap 40 is assembled by being press-fitted in the axial direction, so that the shank seal portion 11 is deformed under pressure at the deepest portion of the seal groove 41 to thereby perform the sealing function between the seal member 10 and the plug cap 40.

In addition, in the seal member 10, since the fixing wall portion 14 of the fixing portion 15 is formed along the peripheral wall portion 22 of the mount hole 21, the support portion of the seal member 10 with respect to the mount hole 21 is not subjected to influence by the shifting due to thermal deformation and/or vibration. Moreover, since the flanged portion 13 is not clamped by the end portion of the peripheral wall portion 22 and the flanged portion 44 of the plug cap 40, the shifting due to the thermal deformation and/or vibration can be further prevented.

Still furthermore, since the seal member 10 of the present embodiment is press-fitted and assembled under small force into the mount hole 21 from the axial outer direction, the seal member can be easily exchanged, and in addition, since it is not necessary to independently provide any fixing means for the seal member 10, the number of components or parts can be reduced, resulting in cost reduction for manufacture, thus being advantageous.

In the above description, although there is proposed an embodiment as the first embodiment in which the seal member 10 is formed only of the elastic material such as rubber, the seal member according to the present invention is not limited to the case of being formed only with the elastic material, and another embodiment in which a seal member according to a second embodiment of the present invention is provided.

### Second Embodiment

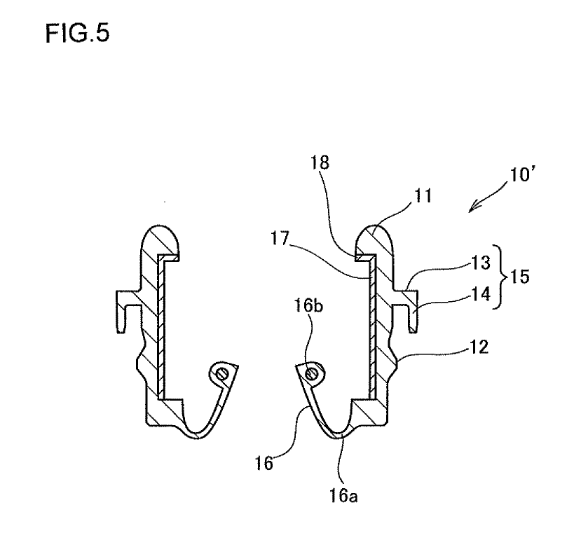

FIG. 5 is a sectional view of a seal member according to the second embodiment of the present invention. It is further to be noted that members or parts same as or similar to those of the first embodiment are described by adding the same reference numerals and detailed explanations thereof are omitted herein.

As shown in FIG. 5, the seal member 10′ according to the second embodiment is formed so as to provide a ring or annular shape, and when the seal member 10′ is inserted into the mount hole 21 formed in the head cover 20, the seal member 10′ is fitted and assembled between the peripheral wall portion 22 of the mount hole 21 and the tubular member 30 fixed to the internal combustion engine.

Further, similar to the seal member 10 according to the first embodiment mentioned hereinbefore, the seal member 10′ is provided, at axial one end thereof, with the axial-direction seal portion 11, and at another end thereof, with a diameter-direction seal portion 12. The axial-direction seal portion 11 is formed so as to project, in the axial direction, from the axial end portion of the seal member 10′, and the diameter-direction seal portion 12 is formed so as to project outward in the diameter direction from the outer peripheral wall portion of the seal member 10′.

Furthermore, a retaining portion 16 is formed on the inner peripheral side of the seal member 10′ so as to closely contact the outer periphery of the tubular member 30 so as to be integral with the lower end portion of the seal member 10′ through a connecting portion 16a. Further, in the seal member 10′ of the present embodiment, the retaining portion 16 is incorporated with an urging member 16b composed of a coil spring or like. By the location of such urging member 16b, the retaining portion 16 can be further forcibly pressed against the tubular member 30.

A fixing portion 15 is further formed to a portion between the axial-direction seal portion 11 and the diameter-direction seal portion 12 along their axial direction, and the fixing portion is provided with a flanged portion 13 projecting outward from the outer peripheral wall portion of the seal member 10′ and a fixing wall portion 14 formed to an end portion of the flanged portion 13 so as to extend downward in parallel with the peripheral wall portion 22.

Furthermore, the seal member 10′ is made of an elastic material, and more specifically, of acrylic rubber, silicone rubber, nitric rubber (NBR), ethylene propylene rubber (EPDM) or like.

In the seal member 10′ according to the present embodiment, a reinforcing member 17 made of metal is assembled along the peripheral wall portion 22, and the reinforcing member 17 has a tubular shape having one end formed with a bent portion bent inward in the diameter direction. Further, the reinforcing member 17 is assembled with the seal member 10′ by means of insert mold method.

As mentioned above, since the reinforcing member 17 has the tubular shape, when the seal member 10′ is press-fitted with small force into the mount hole 21, the diametrically inward deformation of the diameter-direction seal portion 12 can be prevented, and in addition, the axially downward deformation of the axial-direction seal portion 11 can be also prevented. Thus, the separation between the axial-direction seal portion 11 and the diameter-direction seal portion 12 can be suppressed, thereby performing the ensure sealing.

Moreover, the seal member 10′ according to the present embodiment is explained hereinabove as an example in which the coil spring is used as the urging member 16b, but another elastic member such as rubber may be substituted in use for the coil spring without being limited thereto as far as the retaining portion can closely contact the tubular member 30.

It is therefore to be understood that the present invention is not limited to the described embodiments, such as above, and many other changes and modification or alternations will be made within technical range or spirits of the appended claims.

What is claimed is:

1. A seal member having a ring shape which is assembled in a portion between a tubular member to be inserted into and fixed to a mount hole formed to a head cover of an internal combustion engine and a peripheral wall portion of the mount hole, the seal member comprising:
an axial-direction seal portion formed to axial one end portion of the seal member;
a diameter-direction seal portion formed to another one end of the seal member; and
a fixing member formed along a peripheral wall portion of the mount hole and configured to fix movement in a diameter direction of the seal member between the axial-direction seal portion and the diameter-direction thereof.

2. The seal member according to claim 1, wherein the fixing member is provided with a flanged portion extending in the diameter direction and a fixing wall portion extending downward from the flanged portion in parallel with the peripheral wall portion of the mount hole.

3. The seal member according to claim 1, wherein the axial-direction seal portion is formed so as to project from the axial end portion of the seal member in the axial direction thereof.

4. The seal member according to claim 1, wherein the diameter-direction seal portion is formed so as to project from the diameter direction of the seal member.

5. The seal member according to claim 1, further comprising a reinforcing member made of metal disposed along a circumferential direction of the seal member.

6. The seal member according to claim 5, wherein the reinforcing member has an end portion on the axial-direction seal portion side, the end portion being bent in the diameter direction.
